(19) United States
(12) Patent Application Publication
(10) Pub. No.: US 2009/0283593 A1
(43) Pub. Date: Nov. 19, 2009

(54) MERCHANDISE SALES DATA PROCESSING APPARATUS

(75) Inventor: Takuro Masuda, Tokyo (JP)

Correspondence Address: TUROCY & WATSON, LLP, 127 Public Square, 57th Floor, Key Tower, CLEVELAND, OH, 44114, US

(73) Assignee: TOSHIBA TEC KABUSHIKI KAISHA, Tokyo (JP)

(21) Appl. No.: 12/465,746

(22) Filed: May 14, 2009

(30) Foreign Application Priority Data
May 16, 2008 (JP) 2008-129738

(51) Int. Cl. G06K 15/00

(52) U.S. Cl. 235/383; 235/454

(57) ABSTRACT

A merchandise sales data processing apparatus has a scanning section, a facing section and a settlement section laterally arrayed in an X-direction. A shop assistant stands a position that is side by side to the merchandise sales data processing apparatus in a Y-direction. A customer comes to a position that is side by side to the merchandise sales data processing apparatus in the Y-direction on the opposite side. The customer places a shopping basket with an article in it, on the top surface of the facing section. The shop assistant takes the article out of the shopping basket. The shop assistant moves the article in the Y-direction through the space above the facing section. The shop assistant causes the scanning section to optically scan an article code formed as a code symbol attached to the article. The shop assistant carries out settlement based on the article code scanned by the scanning section, by using the settlement section.

### CROSS REFERENCE TO RELATED APPLICATION

This application is based upon and claims the benefit of priority from Japanese Patent Application No. 2008-129738, filed on May 16, 2008, the entire contents of which are incorporated herein by reference.

### TECHNICAL FIELD

The present invention relates to a merchandise sales data processing apparatus which enables a shop assistant to carry out checkout singly or two shop assistants to carry out checkout in collaboration.

### BACKGROUND

A store such as a supermarket has a POS apparatus (merchandise sales data processing apparatus). The POS apparatus has a POS terminal and a code reader.

Checkout includes scanning and settlement. Scanning is an operation to scan an article code with the code reader. The article code is located on the surface of an article as a code symbol. Settlement is an operation for settlement based on the scanned article code.

Conventionally, the code reader and the POS terminal have their respective separate casings. The code reader and the POS terminal are located side by side on the same counter as viewed from the shop assistant side. With such a POS apparatus, shop assistant(s) and a customer stand facing each other whether it is “one-person” checkout or “two-person” checkout. In the “one-person” checkout, only one shop assistant carries out scanning and settlement. In the “two-person” checkout, one shop assistant (checker) carries out scanning and the other shop assistant (cashier) carries out settlement.

An example of such a POS apparatus is a checkout system disclosed in JP-A-2003-281626. This checkout system includes a scanning unit and a settlement unit. The scanning unit and the settlement unit are arranged side by side in this order along the direction in which a customer moves.

In this checkout system, the checker carries out scanning using the scanning unit and the cashier carries out settlement using the settlement unit. There is an article code scanning area between the checker and the scanning unit. The scanning unit has basket placing areas on its both sides. Between the scanning unit and the settlement unit, a basket is placed into which the checker puts an article with its article code scanned. Beside the scanning unit, a basket is placed in which the customer stores an article before checkout. As scanning of an article code, the checker takes out an article from the basket beside the scanning unit and passes the article in front of the scanning unit. Then, the checker puts the article into the basket between the scanning unit and the settlement unit. The cashier waits in front of the settlement unit until the checker takes out all the articles from the basket beside the scanning unit, then passes the articles in front of the scanning unit and puts the articles into the basket between the scanning unit and the settlement unit.

This checkout system requires at least the article code scanning area, the two basket placing areas and the settlement work area for checkout. Therefore, it is difficult to miniaturize the system as a whole.

### SUMMARY

It is an object of the invention to miniaturize a POS apparatus (merchandise sales data processing apparatus) which can employ both one-person and two-person work systems.

According to an aspect of the invention, a merchandise sales data processing apparatus includes: a facing section in which a basket placing area on a customer side for place a shopping basket thereon and a bagging area on a shop assistant side for bagging an article are provided next to each other in a Y-coordinate direction on a top side, thereby securing a facing space between the customer and the shop assistant above the basket placing area and the bagging area; a scanning section provided at a position next to the facing section in an X-coordinate direction without interfering with the facing space, for carrying out scanning to optically scan an article code formed as a code symbol attached to an article, from the shop assistant side; and a settlement section provided at a position next to the facing section in the X-coordinate direction and opposite to the scanning section without interfering with the facing space, for carrying out settlement based on the article code scanned by the scanning section.

According to another aspect of the invention, a checkout method for an article using a merchandise sales data processing apparatus having a scanning section, a facing section and a settlement section laterally arrayed in an X-direction, includes: moving an article at a position arrayed to the merchandise sales data processing apparatus in a Y-direction in a space above the facing section in the Y-direction; causing the scanning section to optically scan an article code formed as a code symbol attached to the article; and carrying out settlement based on the article code scanned by the scanning section, using the settlement section.

### DESCRIPTION OF THE DRAWINGS

A more complete appreciation of the present invention and many of the attendant advantages thereof will be readily obtained as the same becomes better understood by reference to the following detailed description when considered in connection with the accompanying drawings, wherein:

FIG. 1 is a schematic view showing an example of checkout using a POS apparatus (merchandise sale data processing apparatus);

FIG. 2 is a perspective view of the POS apparatus as viewed from its rear side (customer side);

FIG. 3 is a plan view of the POS apparatus;

FIG. 4 is a front view of the POS apparatus;

FIG. 5 is a right side view of the POS apparatus;

FIG. 6 is a left side view of the POS apparatus;

FIG. 7 is a plan view schematically showing how checkout is carried out with the POS apparatus in a one-person system;

FIG. 8 is a plane view schematically showing how checkout is carried out with the POS apparatus in a two-person system;

FIG. 9 is a perspective view of the POS apparatus as viewed from the customer side; and

FIG. 10 is a schematic view showing an example of checkout using the POS apparatus.

### DETAILED DESCRIPTION

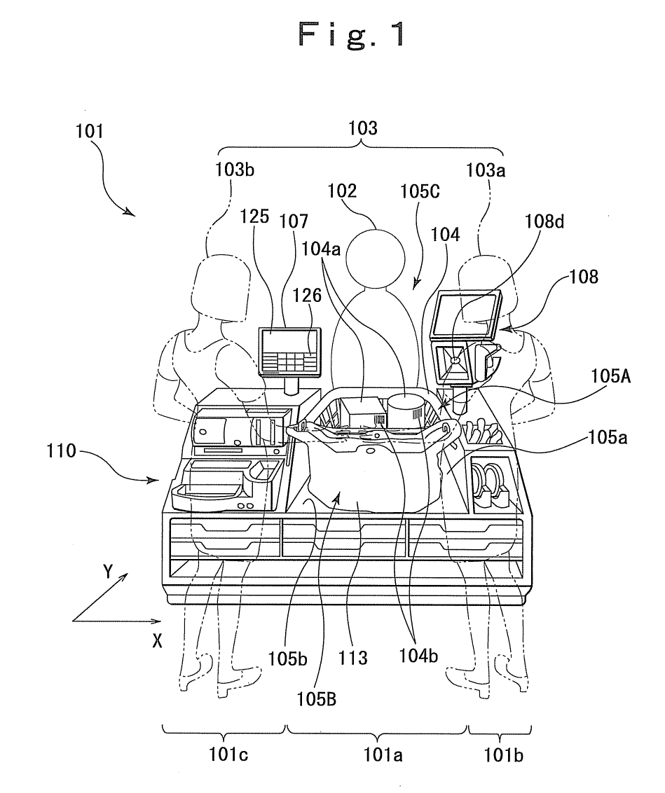

An embodiment will be described with reference to FIG. 1 to FIG. 8. In this embodiment, the invention is applied to a POS apparatus 101 installed in a checkout area of a supermarket.

FIG. 1 is a schematic view showing an example of checkout using the POS apparatus 101. A shop assistant and a customer stand to face each other across the POS apparatus 101. The depth dimension of the POS apparatus 101 is smaller and narrower than its width. The two long sides of the POS apparatus 101 correspond to the shop assistant side and the customer side. A shop assistant 103 stands on the shop assistant side of the POS apparatus 101 and faces the POS apparatus 101 in order to carry out checkout.

In the following description, an “X-coordinate direction” refers to the direction of the width of the POS apparatus 101 as viewed from the shop assistant 103. A “Y-coordinate direction” refers to the direction of the depth of the POS apparatus 101 as viewed from the shop assistant.

The POS apparatus 101 has a scanning section 101b on the right side as viewed from the shop assistant side (that is, on the left side as viewed from the customer side). The shop assistant 103 uses the scanning section 101b for scanning. The scanning section 101b has a code reader 108. The code reader 108 optically scans an article code 104b formed as a code symbol. The article code 104b formed as a code symbol is on the surface of an article 104a.

The POS apparatus 101 has a settlement section 101c on the left side as viewed from the shop assistant side (that is, on the right side as viewed from the customer side). The shop assistant 103 uses the settlement section 101c for settlement. The settlement section 101c realizes settlement based on the article code 104b scanned by the scanning section 101b.

The POS apparatus 101 has a facing section 101a between the scanning section 101b and the settlement section 101c. The facing section 101a has a basket placing area 105a on its customer side. In the basket placing area 105a, a customer places a shopping basket 104. The space above the basket placing area 105a is a basket placing space 105A.

The facing section 101a also has a bagging area 105b on its shop assistant side. The shop assistant 103 bags the article 104a on the bagging area 105b. The space above the bagging area 105b is a bagging space 105B.

The basket placing area 105a and the bagging area 105b are next to each other in the Y-coordinate direction. The basket placing space 105A and the bagging space 105B form a part of a facing space 105C between a customer 102 and the shop assistant 103. Here, the facing section 101a, the scanning section 101b and the settlement section 101c may be integrally formed or separated.

The shop assistant 103 carries out checkout. Checkout includes scanning and settlement. In scanning, the shop assistant 103 causes the code reader 108 to scan the article code 104b on the article 104a. In settlement, settlement based on the articles code 104b scanned by the code reader 108 is carried out. In settlement, the shop assistant 103 carries out operation input from a touch panel 126 as an operation input unit. The shop assistant 103 carries out settlement, looking at a shop assistant display 125.

In the POS apparatus 101, the scanning section 101b and the settlement section 101c are separated. Therefore, the POS apparatus 101 realizes both one-person checkout and two-person checkout. FIG. 1 shows a case of two-person checkout. In this case, one shop assistant 103 serves as a checker 103a. The checker 103a is responsible for scanning. The checker 103a stands on the side of the scanning section 101b. The customer 102 places the shopping basket 104 on the basket placing area 105a. The shopping basket 104 houses the article 104a which the customer 102 plans to purchase. The checker 103a takes the article 104a out of the shopping basket 104 on the basket placing area 105a, then carries out the above scanning, and bags the article 104a on the bagging area 105b. The other shop assistant 103 serves as a cashier 103b. The cashier 103b is responsible for settlement. The cashier 103b stands on the side of the settlement section 101c. The cashier 103b watches the status of scanning by the checker 103a and carries out operation input to start settlement from the touch panel 126.

Hereinafter, the external structure of the POS apparatus 101 will be described in order of the overall structure, the facing section 101a, the scanning section 101b, the settlement section 101c, and the substructure.

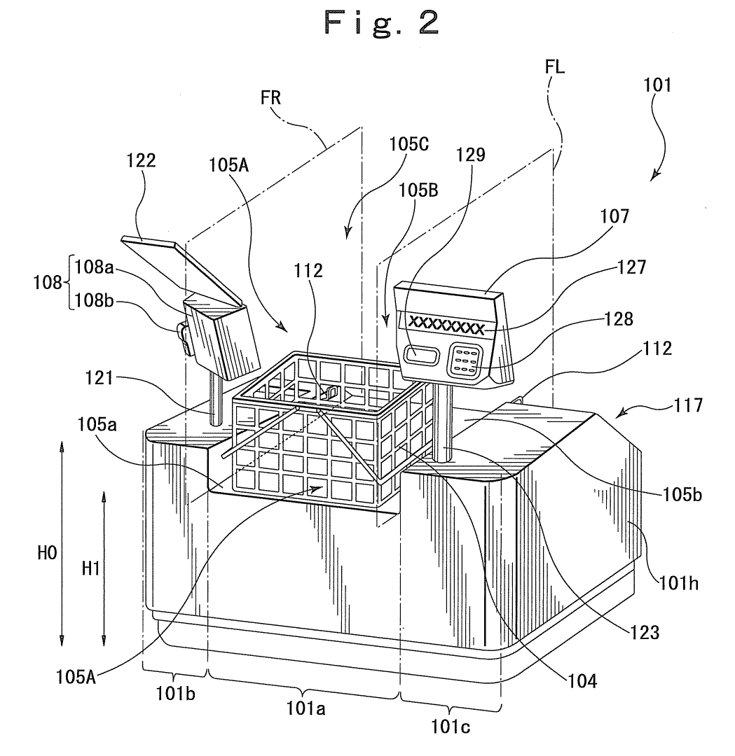

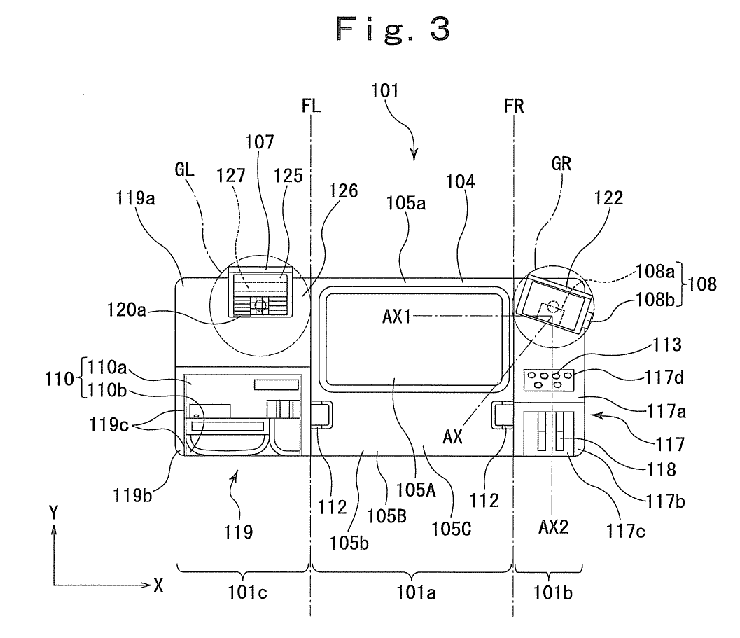

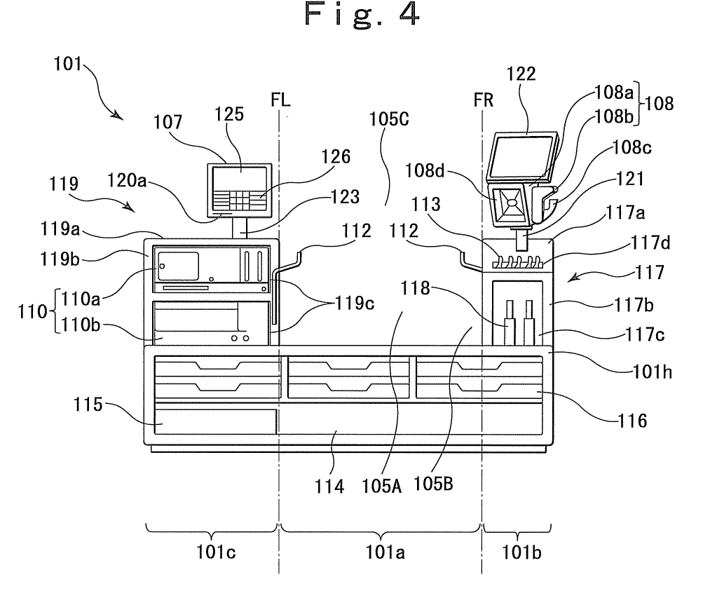

FIG. 2 is a perspective view of the POS apparatus 101 as viewed from its rear side (customer side). FIG. 3 is a plan view of the POS apparatus 101. FIG. 2 and FIG. 3 also show the shopping basket 104 on the basket placing area 105a. FIG. 4 is a front view of the POS apparatus 101.

The overall structure of the POS apparatus 101 will now be described with reference to FIG. 2 to FIG. 4. The POS apparatus 101 is roughly in the shape of a rectangular parallelepiped that is long in the X-coordinate direction. The POS apparatus 101 looks roughly rectangular in a plane view (FIG. 3). The POS apparatus 101 has a base housing 101h. The base housing 101h has a height H0. The height dimension H0 is approximately the height of the waist of the shop assistant 103.

The facing section 101a has a height H1 (H1<H0). The top surface of the facing section 101a is receding in the direction of the floor with respect to the top surface of the scanning section 101b and the settlement section 101c. The facing section 101a has a width dimension equivalent to the length of the longer side of the shopping basket 104. As a result, the POS apparatus 101 looks concave in a front view (viewed from the shop assistant side, FIG. 4) and in a rear view (viewed from the customer side, FIG. 2).

In a left side view (FIG. 6), the base housing 101h looks pentagonal with an upper part on the shop assistant side (the upper right part in FIG. 6) being obliquely cut off the rectangle.

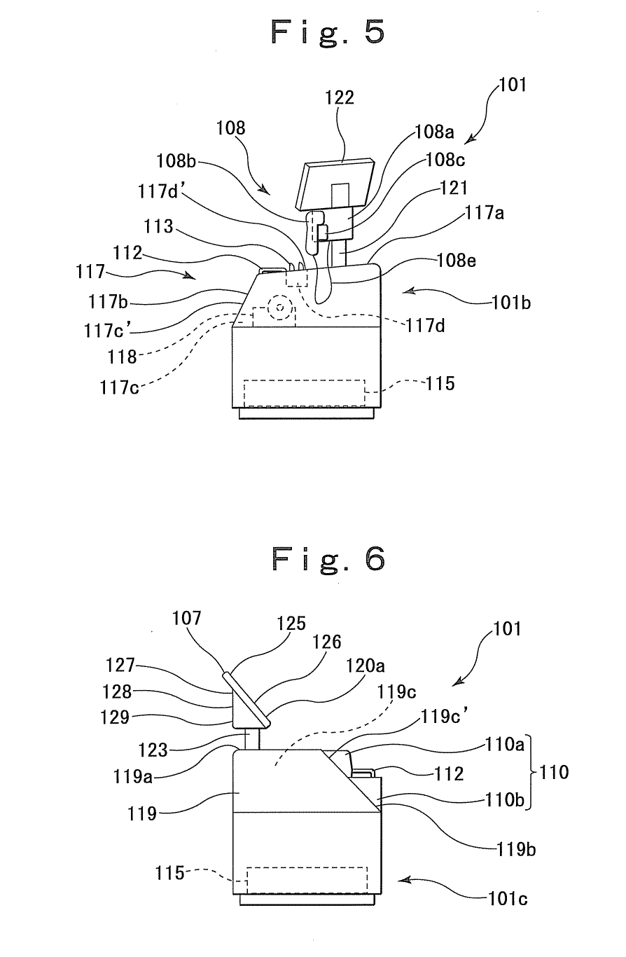

In a right side view (FIG. 5), the base housing 101h appears to have such a shape that the pentagonal shape seen in the left side view (FIG. 6) is turned laterally symmetrically and the top surface is gently inclined so that the shop assistant side (the left side part in FIG. 5) is lowered.

The facing section 101a will now be described with reference to FIG. 2 to FIG. 4. The basket placing area 105a and the bagging area 105b on the facing section 101a are next to each other in the Y-coordinate direction.

On the basket placing area 105a, the shopping basket 104 is placed. On the basket placing area 105a, the long side of the shopping basket 104 faces the direction of the width of the POS apparatus 101. On the basket placing area 105a, the shopping basket 104 is placed without sticking out from the edge on the customer side of the POS apparatus 101.

The bagging space 105B is secured above the bagging area 105b. A pair of bag hooks 112 faces each other across the bagging space 105B. One of the bag hooks 112 is situated on the side toward the bagging area 105b of a tool housing section 117 (which will be described later). The other of the bag hooks 112 is situated on the side toward the bagging area 105b of an automatic money changer housing section 119 (described later). Both bag hooks 112 are situated at parts that do not interfere with the shopping basket 104 on the basket placing area 105a, as shown in FIG. 3. Both bag hooks 112 have their upper parts curved so that a pair of handles of a shopping bag 113 can be hooked thereon. The pair of bag hooks 112 maintains the shopping bag 113 in an open state. The shop assistant 103 stores the article 104a after scanning the article code, into the opened shopping bag 113.

FIG. 5 is a right side view of the POS apparatus 101. The scanning section 101b will now be described with reference to FIG. 2 to FIG. 5. The top surface of the scanning section 101b is protruding upward above the basket placing area 105a. The top surface of the scanning section 101b defines the boundary of the basket placing space 105A and the bagging space 105B in the X-coordinate direction. The scanning section 101b has a tool housing section 117 in the part protruding upward above the basket placing area 105a.

The tool housing section 117 looks roughly trapezoidal in a side view. A tool housing section first surface 117a is in the depths in the Y-coordinate direction on the top surface of the tool housing section 117. The side of tool housing section first surface 117a on the customer side has a height approximately equal to the height of the waist of the customer 102. The tool housing section first surface 117a is gently inclined downward toward the shop assistant side. The tool housing section first surface 117a has an aperture 117d′ on its upper surface. A shopping bag housing space 117d is formed within the tool housing section 117. The shopping bag housing space 117d continues to the aperture 117d′. The shopping bag housing space 117d houses the shopping bag 113.

A tool housing section second surface 117b is on the front side in the Y-coordinate direction on the top surface of the tool housing section 117. The tool housing section second surface 117b is next to the tool housing section first surface 117a. The tool housing section second surface 117b is inclined more sharply than the tool housing section first surface 117a. The side on the shop assistant side of the tool housing section second surface 117b has a height coincident with the height of the basket placing area 105a. The tool housing section second surface 117b has an aperture 117c′ on its shop assistant side. A small item housing space 117c is formed within the tool housing section 117. The small item housing space 117c continues to the aperture 117c′. The small item housing space 117c houses various small items used by the shop assistant 103, such as an adhesive tape 118.

A first pole 121 protrudes upward from a position close to the customer side on the tool housing section first surface 117a. The first pole 121 is laterally arrayed with the basket placing area 105a. The first pole 121 supports the code reader 108. The first pole 121 is a cylinder that is slimmer than the code reader 108.

The code reader 108 has a vertical code scanner 108a and a handy scanner 108b. The vertical code scanner 108a is situated at an intermediate part of the first pole 121. A cord 108e connects the vertical code scanner 108a with the handy scanner 108b. The housing of the vertical code scanner 108a has a hook 108c. The hook 108c is for hanging the handy scanner 108b thereon.

The vertical code scanner 108a has a scanning window 108d. The scanning window 108d faces toward the shop assistant side and obliquely downward. The horizontal component of a direction AX in which the scanning window 108d faces, faces toward the interior angle formed by a direction AX1 facing the basket placing area 105a and a direction AX2 facing the shop assistant side.

Both the vertical code scanner 108a and the handy scanner 108b scan and decode the article code 104b formed as a code symbol. Both the vertical code scanner 108a and the handy scanner 108b input the decoding result to a POS terminal body 115 (see FIG. 6).

A scanning display 122 is situated at the upper end of the first pole 121. The display surface of the scanning display 122 faces toward the shop assistant side and obliquely upward. As an example of the scanning display 122, a liquid crystal slim display can be employed. The scanning display 122 displays the result of scanning the article code 104b by the code reader 108.

The POS apparatus 101 houses the POS terminal body 115 in a lower part of its internal space. Both the code reader 108 (the vertical code scanner 108a and the handy scanner 108b) and the scanning display 122 are connected to the POS terminal body 115 via a connection cord (not shown) passing through the first pole 121.

FIG. 3 will now be referred to. Both the vertical code scanner 108a and the scanning display 122 can freely gyrate around the first pole 121. The gyration range GR of these devices around the first pole 121 does not exceed a virtual right frontier surface FR. This right frontier surface FR coincides with the lateral side of the tool housing section 117 on the basket placing area 105a side. Therefore, the code reader 108 and the scanning display 122 do not interfere with the facing space 105C between the customer 102 and the shop assistant 103. That is, the code reader 108 and the scanning display 122 do not obstruct the movement of the customer 102 who places the shopping basket 104 in the basket placing space 105A. The code reader 108 and the scanning display 122 do not obstruct the movement of the checker 103a, either, who takes the article 104a out of the shopping basket 104, carries out scanning of the article code 104b and bags the article in the bagging space 105B.

FIG. 6 is a left side view of the POS apparatus 101. The settlement section 101c will now be described with reference to FIG. 2, FIG. 3, FIG. 4 and FIG. 6. The top surface of the settlement section 101c protrudes upward above the basket placing area 105a. The top surface of the settlement section 101c defines the boundary of the basket placing space 105A and the bagging space 105B in the X-coordinate direction. The settlement section 101c has the automatic money changer housing section 119 in the part protruding upward above the basket placing area 105a.

The automatic money changer housing section 119 looks trapezoidal in a side view. An automatic money changer housing section first surface 119a is in the depths in the Y-coordinate direction on the top surface of the automatic money changer housing section 119. The automatic money changer housing section first surface 119a is horizontal.

An automatic money changer housing section second surface 119b is on the front side in the Y-coordinate direction on the top surface of the automatic money changer housing section 119. The automatic money changer housing section second surface 119b is next to the automatic money changer housing section first surface 119a. The automatic money changer housing section second surface 119b is inclined so that the front side is lowered. The side of the automatic money changer housing section second surface 119b on the shop assistant side has a height coincident with the height of the basket placing area 105a.

The automatic money changer housing section second surface 119b has an aperture 119c′ on the shop assistant side. An automatic money changer housing space 119c is formed within the automatic money changer housing section 119. The automatic money changer housing space 119c continues to the aperture 119c. The automatic money changer housing space 119c houses an automatic money changer 110 (a bank bill receiving and dispensing device 110a and a coin receiving and dispensing device 110b). Specifically, the automatic money changer housing space 119c has a vertical two-stage configuration. The upper stage houses the bank bill receiving and dispensing device 110a. The lower stage houses the coin receiving and dispensing device 110b.

A second pole 123 protrudes upward from a position close to the customer side on the automatic money changer housing section first surface 119a. The second pole 123 is laterally arrayed with the basket placing area 105a. The second pole 123 is a slim cylinder like the first pole 121. The second pole 123 supports this settlement unit 107 at its upper end.

The settlement unit 107 has a shape of a substantially right-angled triangle as viewed from its side. The hypotenuse of the settlement unit 107 faces upward on the shop assistant side. The vertical side of the settlement unit 107 faces the customer side. The shop assistant display 125 is situated on the surface of the settlement unit 107 facing the shop assistant side. As an example of the shop assistant display 125, a slim liquid crystal display can be used. The touch panel 126 as the operation input unit covers the display surface of the shop assistant display 125. Here, the surface of the settlement unit 107 on the shop assistant side functions as a shop assistant interface having an information display function and an information input function.

The shop assistant display 125 has an issue port 120a in the lower left part of the shop assistant display 125. The settlement unit 107 houses a receipt printer 120 therein. The receipt printer 120 prints and issues a receipt (not shown). The issue port 120a discharges the receipt (not shown).

The settlement unit 107 has, on its customer-side surface, a customer display 127, an IC card reader writer 129, and a ten-key panel 128. The customer display 127 has an LED display device. The IC card reader writer 129 enables settlement with an IC card (not shown). The ten-key panel 128 realizes multi-digit input. For example, the ten-key panel 128 is used to input the personal identification number of the customer 102 in settlement with an IC card.

Here, as a modification, the settlement unit 107 may have a magnetic reader therein and have a slit to pass a credit card through, on the surface on the shop assistant side. In this case, the settlement unit 107 realizes settlement with a credit card.

All of the shop assistant display 125, the touch panel 126, the customer display 127, the ten-key panel 128, the IC card reader writer 129 and the receipt printer 120 are connected to the POS terminal body 115 via a connection cord (not shown) passing through the second pole 123.

FIG. 3 will now be referred to. The settlement unit 107 can freely gyrate around the second pole 123. The gyration range GR of the settlement unit 107 around the second pole 123 does not exceed a virtual left frontier surface FL. This left frontier surface FL coincides with the lateral surface of the automatic money changer housing section 119 on the basket placing area 105a side. Therefore, the settlement unit 107 does not interfere with the facing space 105C between the customer 102 and the shop assistant 103. That is, the settlement unit 107 does not obstruct the movement of the customer 102 who places the shopping basket 104 in the basket placing space 105A. The settlement unit 107 does not obstruct the movement of the checker 103a, either, who takes the article 104a out of the shopping basket 104, carries out scanning of the article code 104b and bags the article in the bagging space 105B.

FIG. 4 will now be referred to. Next, the substructure of the POS apparatus 101 will be described with reference to FIG. 4. The base housing 101h of the POS apparatus 101 forms an inner housing space 114 below the basket placing area 105a. The inner housing space 114 extends across the settlement section 101c, the facing section 101a and the scanning section 101b. The inner housing space 114 is wide open to the shop assistant side. In a top part of the inner housing space 114, six drawers 116 are installed in such a manner that these drawers can be drawn out toward the shop assistant. The drawers 116 are arrayed in the form of two rows by three columns in the inner housing space 114. The POS terminal body 115 is housed in the depths on the left side of the inner housing space 114. The POS terminal body 115 drive-controls the bank bill receiving and dispensing device 110a, the coin receiving and dispensing device 110b, the settlement unit 107, the code reader 108 and the scanning display 122. The POS terminal body 115 is a general-purpose computer. The POS terminal body 115 has a CPU, a ROM, a RAM and a hard disk. The hard disk of the POS terminal body 115 stores an operating system, a driver program, and various application programs. The hard disk also stores a merchandise data file. The merchandise data file stores article codes in association with article information including article unit prices.

The code reader 108 inputs the inputted article code 104b. The CPU of the POS terminal body 115 acquires the article information corresponding to the article code 104b from the merchandise data file. The CPU then generates accounting information based on this article information. Next, the CPU executes settlement of the amount of payment of the customer 102 based on this accounting information. In this series of processing, the CPU causes the scanning display 122 to display whether scanning of the article code 104b by the code reader 108 is normally carried out or is a failure. The shop assistant display 125 and the customer display 127 display various kinds of information as accounting information. Examples of accounting information include the article unit price and article name corresponding to the scanned article code 104b. The shop assistant 103 (particularly the cashier 103b) operates the touch panel 126 to carry out settlement. As this settlement is carried out, the automatic money changer 110 dispenses cash as change. The issue port 120a discharges a receipt (not shown).

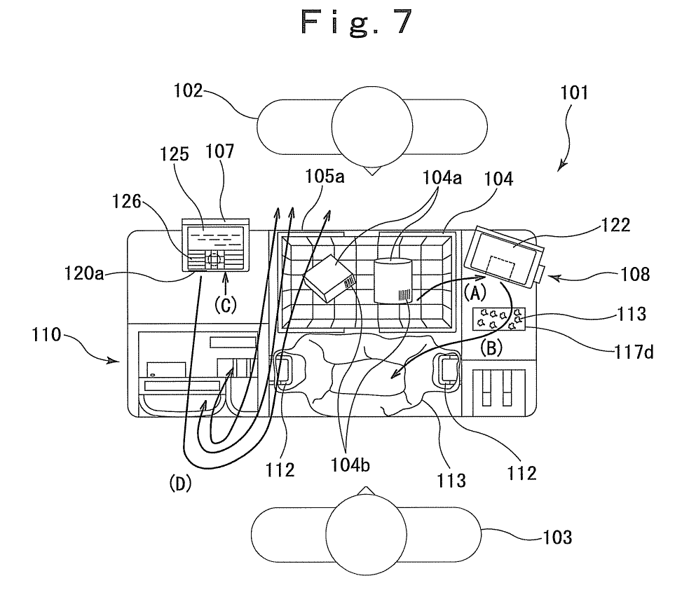

FIG. 7 is a plan view schematically showing how checkout is carried out in a one-person system by using the POS apparatus 101. Before checkout, the shop assistant 103 takes out a shopping bag 113 from the shopping bag housing space 117d. The shop assistant 103 sets the shopping bag 113 that is taken out, on the bag hooks 112. At this time, the shopping bag 113 clearly shows the space area of the basket placing space 105A.

The customer 102 houses the article 104a which the customer plans to purchase, into the shopping basket 104. The customer 102 places the shopping basket 104 in the basket placing space 105A. At this time, the shopping basket 104 does not strike any of the code reader 108, the scanning display 122 and the settlement unit 107. The basket placing area 105a is lowered into the direction of the floor. The tool housing section 117, the automatic money changer housing section 119, and the shopping bag 113 set on the bag hooks 112 surrounds the basket placing space 105A. Therefore, the customer 102 can easily position the shopping basket 104 in the basket placing space 105A.

The one-person checkout will now be described with reference to FIG. 7. The shop assistant 103 waits on the shop assistant side of the POS apparatus 101. The shop assistant 103 faces straight toward the facing section 101a.

As checkout starts, the shop assistant 103 turns the body slightly to the right. The shop assistant 103 faces the code reader 108. The shop assistant 103 takes up the article 104a in the shopping basket 104 with his or her hand. The shop assistant 103 moves the article 104a along the arrow A. The shop assistant 103 holds the article code 104b on the surface of the article 104a to the scanning window 108d of the vertical code scanner 108a. The scanning display 122 displays the result of scanning of the article code 104b. After confirming the result of scanning of the article code 104b, the shop assistant 103 moves the article 104a along the arrow B and puts the article 104a into the shopping bag 113. Here, the shop assistant 103 may scan the article code 104b by using the handy scanner 108b. After the scanning, the shop assistant 103 faces toward the settlement unit 107. To proceed to settlement, the shop assistant 103 carries out operation input from the touch panel 126 along the arrow C. During settlement, the shop assistant 103 receives money from and gives money to the customer 102 and hands a receipt over to the customer 102, along the arrows D.

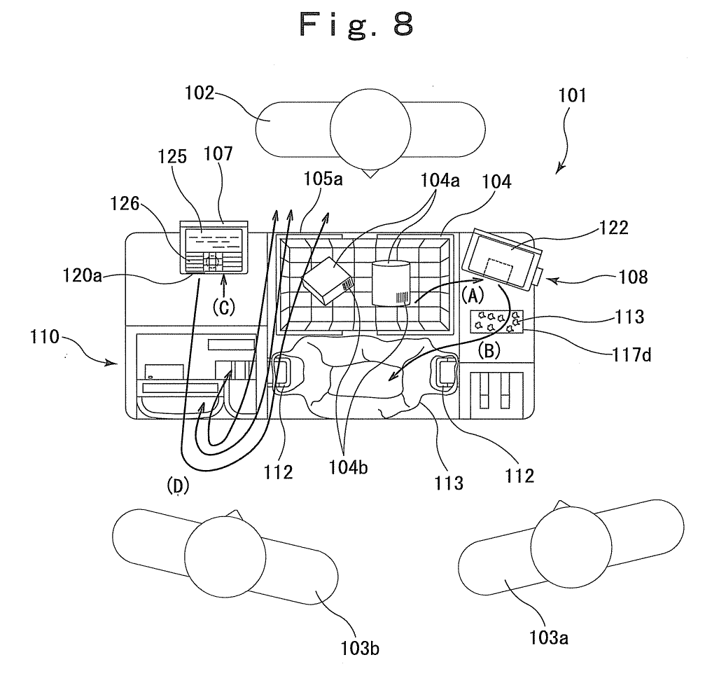

FIG. 8 is a plan view schematically showing how checkout is carried out in a two-person system using the POS apparatus 101. The two-person checkout will now be described with reference to FIG. 8. The two-person checkout requires two shop assistants 103, that is, the checker 103a and the cashier 103b. The checker 103a faces straight toward the scanning section 101b. The cashier 103b faces straight toward the settlement section 101c. The checker 103a and the cashier 103b stand at a distance approximately equal to the width dimension of the facing section 101a.

As checkout starts, first, the checker 103a carries out scanning of the article code 104b along the flow indicated by the arrow A. Then, the checker 103a puts the article 104a with its article code 104b already scanned into the shopping bag 113, along the flow indicated by the arrow B. The cashier 103b estimates the timing of the end of scanning by the checker 103a. The cashier 103b carries out operation input from the touch panel 126, along the flow indicated by the arrow C. Then, the cashier 103b receives and gives money and hands a receipt over to the customer 102 along the flows indicated by the arrows D.

In the scanning, the article 104a does not traverse in the X-coordinate direction in front of the scanning unit 101b. The article 104a moves in the Y-coordinate direction (in the direction to the front of the shop assistant 103) from the customer side to the shop assistant side of the facing section 101a. Then, before and after the scanning of the article code, the article 104a is on one side (left side) of the scanning section 101b above the basket placing area 105a. That is, the POS apparatus 101 does not have to secure basket placing areas for placing two shopping baskets 104 on both sides in the X-coordinate direction of the scanning section 101b. As a result, the POS apparatus 101 can be miniaturized.

During the checkout using the POS apparatus 101, the customer 102 and shop assistants 103 face each other across the central part of the POS apparatus 101. Here, the POS apparatus 101 secures the facing space 105C above the facing section 101a. The scanning section 101b and the settlement section 101c do not enter the facing space 105C. Therefore, the customer 102 does not have his or her vision obstructed at all throughout the facing space 105C and can see the handling of a transaction by the shop assistants 103 (the checker 103a and the cashier 103b). As a result, the customer 102 does not have to worry about the transaction, such as suspecting that “the shop assistants may be taking an improper action” as the customer cannot see the handling of the transaction by the shop assistants 103.

Moreover, the top surface of the facing section 101a is lowered into the direction of the floor. Therefore, the facing space 105C is large in the direction of height. In addition, the code reader 108 and the settlement unit 107 are located at the top of the slim poles such as the first pole 121 and the second pole 123. Therefore, the customer 102 can see the shop assistants 103 (the checker 103a and the cashier 103b) from the side of the first pole 121 and the second pole 123. Moreover, the customer 102 can easily visually recognize the handling by the shop assistants 103 even when the customer stands away from the POS apparatus 101.

The checker 103a lifts up the articles 104a one by one and repeats the operation to cause the code reader 108 to scan the article code 104b of each article 104a. On the other hand, the settlement by the cashier 103b starts only when the scanning by the checker 103a is finished. Therefore, the checker 103a may feel a sense of unfairness about the sharing of the checkout work. To deal with this, in the POS apparatus 101 according to this embodiment, the cashier 103b can support the bagging by the checker 103a. Specifically, the cashier 103b turns the body to the right in front of the settlement section 101c. The cashier 103b receives the article 104a with its article code already scanned, from the checker 103a. The cashier 103b puts the article 104a into the shopping bag 113. Thus, the checker 103a can concentrate on the work to take out the article 104a from the shopping basket 104 positioned in the basket placing space 105A and cause the code reader 108 to scan the article code 104b. At this time, the checker 103a does not have to do bagging. In short, the checkout by the checker 103a is made more efficient.

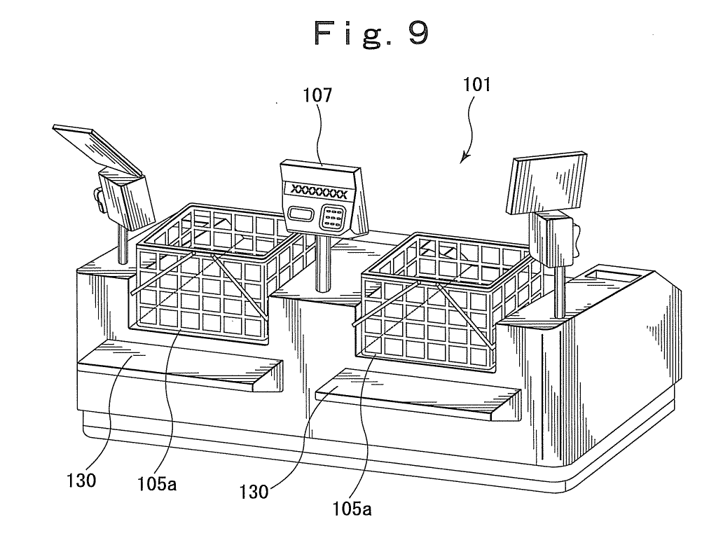

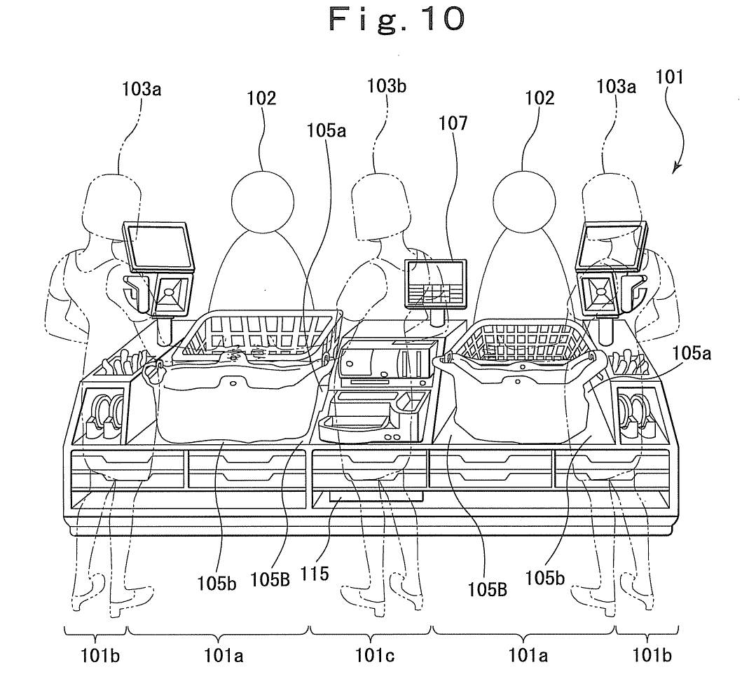

Next, a modification of the POS apparatus 101 will be described with reference to FIG. 9 and FIG. 10. In this case, the same parts as those of the foregoing POS apparatus 101 are denoted by the same reference numerals and will not be described further in detail.

FIG. 9 is a perspective view of the POS apparatus 101 as viewed from the customer side. The POS apparatus 101 according to this modification has a pair of facing sections 101a and a pair of scanning sections 101b. The pair of facing sections 101a is situated on both sides of a single settlement section 101c in the X-coordinate direction. The pair of scanning sections 101b is situated on both sides of the pair of facing section 101a in the X-coordinate direction. Therefore, the POS apparatus 101 roughly appears to have an E-shape turned on its side, in both a front view and a rear view. The POS apparatus 101 also has two temporary placement tables 130. The customer 102 places his or her luggage on the temporary placement tables 130 at the time of checkout. The temporary placement tables 130 are situated below the basket placing areas 105a, respectively. The temporary placement tables 130 protrude toward the customer from the surface of the POS apparatus 101 facing the customer side.

In the case of the one-person checkout, the shop assistant 103 stands facing one of the facing sections 101a.

In the case of the two-person checkout, the checker 103a stands in front of the scanning section 101b. The cashier 103b stands in front of the settlement section 101c.

FIG. 10 is a schematic view showing an example of checkout using the POS apparatus 101 according to this modification. The POS apparatus 101 according to this modification realizes three-person checkout by two checkers 103a and one cashier 103b. The cashier 103b uses one settlement unit 107 to carry out settlement based on the article code 104b scanned by two code readers 108.

The lateral width of the POS apparatus 101 according to this modification is shorter than the length formed by laterally arraying two of the POS apparatuses 101 described above with reference to FIG. 1 to FIG. 8. However, the POS apparatus 101 according to this modification has two facing sections 101a and two scanning sections 101b. Therefore, the POS apparatus 101 can handle checkout of twice as many customers 102. In this case, the workload of the cashier 103b increases. Therefore, the sense of unfairness which the checkers 103a may feel in sharing the checkout work is reduced.

Each of the code readers 108 has a specifying code for specifying each code reader. In settlement, the cashier 103b enters the specifying code from the touch panel 126 and thus designates which code reader 108 is used to scan the article code 104b for carrying out this settlement. The POS terminal body 115 calculates the amount of payment with respect to the article code 104b entered from the code reader 108 having the designated specifying code.

The POS apparatus 101 according to this modification requires a smaller area for installation in the store than in the case where two POS apparatuses 101 described with reference to FIG. 1 to FIG. 8 are introduced. Also, the POS apparatus 101 according to this modification reduces the number of workers required, by one. The POS apparatus 101 according to this modification can also handle checkout of twice as many customers 102.

Obviously, numerous modifications and variations of the present invention are possible in light of the above teachings. It is therefore to be understood that within the scope of the appended claims, the invention may be practiced otherwise than as specifically described herein.

What is claimed is:

1. A merchandise sales data processing apparatus comprising:
a facing section in which a basket placing area on a customer side for place a shopping basket thereon and a bagging area on a shop assistant side for bagging an article are provided next to each other in a Y-coordinate direction on a top side, thereby securing a facing space between the customer and the shop assistant above the basket placing area and the bagging area;
a scanning section provided at a position next to the facing section in an X-coordinate direction without interfering with the facing space, for carrying out scanning to optically scan an article code formed as a code symbol attached to an article, from the shop assistant side; and
a settlement section provided at a position next to the facing section in the X-coordinate direction and opposite to the scanning section without interfering with the facing space, for carrying out settlement based on the article code scanned by the scanning section.

2. The apparatus according to claim 1, wherein the scanning section includes a code reader supported by a first pole, and
the settlement section includes an operation input section supported by a second pole and adapted for carrying out various operation inputs.

3. The apparatus according to claim 2, further comprising a pair of bag hooks arranged on both sides in the X-coordinate direction of the bagging area and facing each other across the bagging area, the pair of bag hooks having a pair of handles of a shopping bag hooked thereon and holding the shopping bag in an open state.

4. The apparatus according to claim 1, wherein the top surface of the facing section is lowered in a direction of floor with respect to the scanning section and the settlement section.

5. The apparatus according to claim 2, wherein the top surface of the facing section is lowered in a direction of floor with respect to the scanning section and the settlement section.

6. The apparatus according to claim 3, wherein the top surface of the facing section is lowered in a direction of floor with respect to the scanning section and the settlement section.

7. The apparatus according to claim 1, wherein a pair of the facing sections is arranged on both sides in the X-coordinate direction of the single settlement section situated at the center, and
a pair of the scanning sections is arranged on both sides in the X-coordinate direction of a pair of the facing sections.

8. The apparatus according to claim 2, wherein a pair of the facing sections is arranged on both sides in the X-coordinate direction of the single settlement section situated at the center, and
a pair of the scanning sections is arranged on both sides in the X-coordinate direction of a pair of the facing sections.

9. The apparatus according to claim 3, wherein a pair of the facing sections is arranged on both sides in the X-coordinate direction of the single settlement section situated at the center, and
a pair of the scanning sections is arranged on both sides in the X-coordinate direction of a pair of the facing sections.

10. The apparatus according to claim 4, wherein a pair of the facing sections is arranged on both sides in the X-coordinate direction of the single settlement section situated at the center, and
a pair of the scanning sections is arranged on both sides in the X-coordinate direction of a pair of the facing sections.

11. The apparatus according to claim 5, wherein a pair of the facing sections is arranged on both sides in the X-coordinate direction of the single settlement section situated at the center, and
a pair of the scanning sections is arranged on both sides in the X-coordinate direction of a pair of the facing sections.

12. The apparatus according to claim 6, wherein a pair of the facing sections is arranged on both sides in the X-coordinate direction of the single settlement section situated at the center, and
a pair of the scanning sections is arranged on both sides in the X-coordinate direction of a pair of the facing sections.

13. A checkout method for an article using a merchandise sales data processing apparatus having a scanning section, a facing section and a settlement section laterally arrayed in an X-direction, the method comprising:
moving an article at a position arrayed to the merchandise sales data processing apparatus in a Y-direction in a space above the facing section in the Y-direction;
causing the scanning section to optically scan an article code formed as a code symbol attached to the article; and
carrying out settlement based on the article code scanned by the scanning section, using the settlement section.

14. The method according to claim 13, wherein the merchandise sales data processing apparatus has a pair of bag hooks provided to both sides in an X-coordinate direction of a space close to the position above the facing section,
the method includes having a pair of handles of a shopping bag hooked on the pair of bag hooks and holding the shopping bag in an open state, and
putting an article after scanning the article code, into the open shopping bag.
